(19) United States
(12) Patent Application Publication
(10) Pub. No.: US 2007/0021952 A1
(43) Pub. Date: Jan. 25, 2007

(54) General graphical Gaussian modeling method and apparatus therefore

(75) Inventor: Shigeru Saito, Adachi-ku (JP)

Correspondence Address: PEARNE & GORDON LLP, 1801 EAST 9TH STREET, SUITE 1200, CLEVELAND, OH, 44114-3108, US

(73) Assignee: Infocom Corporation, Tokyo (JP)

(21) Appl. No.: 11/186,277

(22) Filed: Jul. 21, 2005

(51) Int. Cl. G06G 7/48; G06G 7/58

(52) U.S. Cl. 703/11

(57) ABSTRACT

A graphical Gaussian modeling method capable of speedily and accurately estimating a genetic network from an expression profile and an apparatus therefore are provided. The present invention provides a graphical Gaussian modeling method for estimating a genetic network including the steps of (a) clustering genes based on an expression profile, (b) selecting genes having a profile closest to a mean value of an expression profile per cluster to be used as representative genes representing the cluster, (c) obtaining a correlation coefficient matrix among representative genes, (d) obtaining a partial correlation coefficient matrix from the correlation coefficient matrix, (e) contracting the partial correlation coefficient matrix according to predetermined conditions and (f) displaying a contracted model based on the contracted partial correlation coefficient matrix.

### BACKGROUND OF THE INVENTION

1. Field of the Invention

The present invention relates to a general graphical Gaussian modeling method for estimating a genetic network and an apparatus therefore.

2. Description of the Related Art

The recent progress in a DNA micro array technology allows expressions of thousands of genes to be measured simultaneously under different circumstances. The “different circumstances” here refer to various stages of a cell cycle, differences in cell differentiation, versatility of somatic cells, different clinical conditions or different species. Some of these circumstances can be sequenced. For example, stages of a cell cycle and cell differentiation can be sequenced with respect to a lapse of time.

An expression level of a group of genes measured under various circumstances is called an “expression profile of genes” here. Important knowledge of genetic functions and an adjustment mechanism can be obtained through an evaluation of a pattern of this expression profile. For example, several groups have developed a method of carrying out a cluster analysis based on a similarity in the expression profile about genes on a micro array. The “cluster analysis” here refers to identifying a group of genes on a micro array showing similar expression patterns under different measuring circumstances and classifying it as a cluster. For example, hierarchic clustering (Eisen et al. 1998), self-organizing mapping (Tomaya et al. 1999) and other clustering methods (Ben-Dor et al. 1999) are applied to expression profile data.

Clustering genes through an expression profile contributes to functional prediction of gene products whose function is unknown and identification of a genetic group which has been adjusted with the same mechanism.

Among the important information included in a genetic expression profile is an inter-gene expression network. An expression level of one gene is directly or indirectly adjusted to those of other genes. Here, such a network among genes is called a “genetic network.”

Estimating a genetic network from a certain expression profile is an important theme of a functional genomics. A Boolean network (Somogyi and Shiegoski, 1996), differential equation (Chen et al., 1999; D'haeseleer et al., 1999) and modeling using a combination of these methods (Akutsu et al., 1998) are under study for estimating a genetic network. Furthermore, a method of estimating a genetic network using graphical Gaussian modeling is also proposed.

However, when representative genes are selected from each cluster according to the conventional methods, for example, L genes are numbered 1 to L and the gene having the smallest number in each cluster is considered as the representative gene. This results in a problem that when the sequence of input data changes, a gene selected as the representative of a cluster also changes. Furthermore, there is another problem that when the size and distribution of a cluster are large, if a vector far from an average is selected, features of the cluster are not reflected.

In view of the above described circumstances, it is an object of the present invention to provide a graphical Gaussian modeling method capable of estimating a genetic network from an expression profile speedily and accurately and an apparatus therefore.

### BRIEF SUMMARY OF THE INVENTION

In order to attain the above described object, the present invention provides a graphical Gaussian modeling method for estimating a genetic network comprising the steps of:

(a) clustering genes based on an expression profile of genes;

(b) selecting genes having a profile closest to a mean value of an expression profile per cluster to be used as representative genes representing the cluster;

(c) obtaining a correlation coefficient matrix among representative genes;

(d) obtaining a partial correlation coefficient matrix from the correlation coefficient matrix;

(e) contracting the partial correlation coefficient matrix according to predetermined conditions; and

(f) displaying a contracted model based on the contracted partial correlation coefficient matrix.

Furthermore, the above described clustering also provides a graphical Gaussian modeling method which proceeds with clustering until a maximum number of clusters is reached when the value of VIF falls below a predetermined reference value, and the step of selecting the representative genes also provides a method of selecting genes for which the sum of a cluster mean value and a square error becomes a minimum as the representative genes. The step of contracting the above described partial correlation coefficient matrix according to predetermined conditions is a method of deciding whether the result of χ square testing of deviance of a correlation coefficient matrix is equal to or greater than a predetermined value or not, further proceeding with contraction when the χ square testing result is equal to or greater than the predetermined value, repeating the decision whether the χ square testing result of the correlation coefficient matrix is equal to or greater than the predetermined value or not and finishing contraction when the χ square testing result falls below a predetermined value.

When these methods are implemented as an apparatus, it is possible to provide a graphical Gaussian modeling apparatus which estimates and displays a genetic network, comprising:

(a) an input section which receives the input of a genetic expression profile;

(b) a calculation section which clusters genes based on a genetic expression profile, selects genes having a profile closest to a mean value of an expression profile per cluster to be used as representative genes representing the cluster, obtains a correlation coefficient matrix among the representative genes, obtains a partial correlation coefficient matrix from the correlation coefficient matrix and can contract the partial correlation coefficient matrix according to predetermined conditions; and

(c) an output section which displays a contracted model based on the contracted partial correlation coefficient matrix.

### BRIEF DESCRIPTION OF THE DRAWINGS

FIG. 1 is a block diagram of a graphical Gaussian modeling apparatus for estimating a genetic network;

FIG. 2 is a flow chart of a graphical Gaussian modeling method for estimating a genetic network;

FIG. 3 shows plotting of variations in p-values of dev1 and dev2 in the process of a GGM iterative calculations with respect to an iteration step;

FIG. 4 illustrates a final PCCM of 34 representative genes obtained by the GGM;

FIG. 5 shows 34 independent clusters displaying only clusters having absolute values of partial correlation coefficients exceeding 0.5. 0.5 to 0.55 are represented by dotted lines made up of segments of different lengths. 0.55 to 0.6 are represented by dotted lines made up of segments of the same length. 0.6 to 0.7 are represented by thin solid lines. 0.7 to 0.8 are represented by thick solid lines;

FIG. 6 shows a PCCM summarized in a histogram form to characterize an adjustment mechanism of an estimated genetic network. The horizontal axis indicates a partial correlation coefficient. For a calculation of frequency, the partial correlation coefficient is rounded to discrete data having a width of 0.1. The vertical axis indicates the frequency of coefficients within the width. However, the frequency of 0.0 of the partial correlation coefficient is plotted with respect to 0.0 on the horizontal axis;

FIG. 7 is a collection of PCCM elements related to clusters 7, 11, 12, 23 and 25;

FIG. 8 shows experiment results using a conventional graphical Gaussian modeling method; and

FIG. 9 shows experiment results when using a method of the present invention to select representative genes of clusters.

### DESCRIPTION OF SYMBOLS

1 Input apparatus
2 Expression profile input section
3 Correlation coefficient matrix calculation section
4 Cluster analysis section
5 Representative gene correlation coefficient matrix calculation section
6 Graphical Gaussian modeling execution section
7 Partial correlation coefficient matrix transformation section
8 Minimum element search section
9 Correlation coefficient matrix inverse transformation section
10 Significance decision section
11 Partial correlation coefficient matrix output section
12 Output apparatus
13 CPU (central processing unit)
14 Storage apparatus

### DETAILED DESCRIPTION OF THE INVENTION

The present invention especially shows a new method for estimating a genetic network from an expression profile. This is an application of a method called “graphical Gaussian modeling.” The graphical Gaussian modeling is one of technologies for a multi-variate analysis and used to estimate or detect a statistical model expressed in a graph. The present invention has taken advantage of the features of this “graphical Gaussian modeling” and developed a new method of estimating a genetic network combined with a cluster analysis. This method is characterized by not requiring a combination with a gene fracture experiment, etc., as in the case of a conventional method using a differential equation. That is, the present invention is a proposal which applies graphical Gaussian modeling to an expression profile.

The method for estimating a genetic network consists of two stages of a cluster analysis and graphical Gaussian modeling. First, the expression profile data is transformed into a genetic correlation coefficient matrix for an analysis. The graphical Gaussian modeling includes a covariance selection (Dempster 1972). The covariance selection requires a calculation of an inverse matrix of a correlation coefficient matrix. As shown in a cluster analysis of expression profile data (Eisen et al. 1998), many genes show similar expression patterns. Due to the similarity among expression patterns, a pseudo linear subordinate relationship is produced between several columns or rows of the correlation coefficient matrix. This makes it difficult to obtain an inverse matrix through numerical calculations.

To avoid this problem, a cluster analysis is performed first and a cluster is identified so that no pseudo linear subordinate relationship is produced between gene pairs which belong to different clusters. A gene closest to a mean value is selected from each cluster as a representative gene. Next, a correlation coefficient matrix is obtained from the genetic expression profile data of the selected genes and graphical Gaussian modeling is performed using the correlation coefficient matrix.

Therefore, the present invention does not relate to a network among genes but relates to a network formed among several gene groups.

(Expression profile data) Suppose L genes exist on a micro array. Also suppose the number of situations in which the expression level is measured is N. Then, the genetic expression profile is expressed by a two-dimensional matrix E having a size of L×N. An element (i, j) of this matrix E indicates the expression level in a jth situation of an ith gene. The expression profile data was data over a cell cycle of Sacchariomyces cereviae obtained from a web site (http://rana.stanford.edu/clustering).

(Cluster analysis) Here, a method by Horimoto et al. was used for a cluster analysis. However, the cluster analysis is not limited to this method. That is, it is also possible to use the result of a cluster analysis using any other method if it is at least a method which produces a result that eliminates the pseudo linear subordinacy among genes which are constituents of the respective clusters as a result of the cluster analysis.

A representative gene is selected from each cluster. Here, an average profile which is an arithmetic mean of a genetic profile of each cluster is calculated and a gene whose square error is a minimum (closest) to this vector is regarded as a representative gene. An advantage of this method is that the result is determined uniquely, that is, genes selected as the cluster representative are the same even if the input data sequence changes. Furthermore, as the selected genes, there is a high probability that genes reflecting features of the cluster may be selected. It is further possible to proceed with clustering until the maximum number of clusters is reached when the value of VIF falls below a predetermined reference value.

(Graphical Gaussian modeling) To understand the graphical Gaussian modeling, a concept of conditional independency is important. First, this concept will be explained.

Suppose a set of M genes as an example. The genetic expression levels of these M genes are measured under certain conditions. The genetic expression levels of these M genes measured under certain conditions are expressed as an M-dimensional vector [el(Gene 2), el(Gene 3), . . . , el(Gene M)]. Here, the vector element el (gene i) indicates the expression level of the gene i. Suppose f is a simultaneous density function of the M-dimensional vector.

Consider a case where genes A and B show a correlation with respect to an expression profile. The following three mechanisms can be considered as the mechanisms for a correlation to take place between two genes.

The first mechanism is a case where there is a direct interaction between genes. This type of interaction is necessary to estimate a genetic network.

The second mechanism is a case where there is an indirect interaction between two genes. In other words, it is a case where information on the adjustment of a product of the gene A is transmitted so as to provoke an expression of the gene B through expressions of several other genes.

The third mechanism is a correlation generated by being adjusted by a common gene.

To estimate a genetic network, it is important to distinguish the first type of interaction from other types of interaction.

Next, consider an M-dimensional vector simultaneous density function. When this simultaneous density function is factorized into two elements; one not including el (gene B) and the other not including el (gene A), the el (gene A) and el (gene B) are said to be conditionally independent of each other when anything other than them are given.

Expression: f[el(Gene 1), el(Gene 2), . . . el(Gene A), . . . el(Gene B), . . . , el(Gene M)]=h[el(Gene A), the rest]×k[el(Gene B), the rest], where h is a function not including e1 (gene B), k is a function not including el (gene A). This rule is called a factorization reference (Dawid, 1979). The conditional independency means that two expression levels are not directly related to each other. To avoid complexity of description hereafter, the establishment of the conditional independency between el (gene A) and el (gene B) will be referred to as the gene A being conditionally independent of the gene B. When these two genes are conditionally independent, this means that there can be a correlation between them but there is no direct interaction between them. To express the conditional independency among M genes here, consider a graph g=(v, e). v is a finite set of vertices corresponding to M genes and e is a finite set of sides connecting two vertices.

The graph g can be constructed by repeatedly adapting a factorization reference so as to eliminate sides between vertices corresponding to genes whose expression levels are conditionally independent. At this time, e is made up of sides connecting a pair of genes having expression levels which are not conditionally independent when other elements are given. The graph obtained can be considered to express a genetic network among M genes. Here, consider that graphical Gaussian modeling is applied to genetic expression profile data of genes whose number is reduced through the aforementioned cluster analysis. The expression profile data of those genes is expressed by an M×N two-dimensional real matrix. Here, M is the number of genes reduced by a cluster analysis and N is the number of conditions whose expression levels are measured. It goes without saying that L>M. To construct a model, suppose M measured values el (Genes 1 to M) are a random vector having the following simultaneous distribution function.

Expression: fθ[el(Gene 1), el(Gene 2), . . . el(Gene A), . . . el(Gene B), . . . el(Gene M)], where θ is an unknown parameter. The two-dimensional matrix expressing the aforementioned expression profile can be considered as a sample obtained from N observations independent of fθ. Furthermore, suppose the parameter θ is designed so as to include information on the conditional independency among genetic expression levels. Therefore, the graph structure is estimated by estimating the parameter θ. However, the description of the density function using f and θ is too general to perform specific estimation. To estimate a graph structure related to continuous data, a multi-variate normal distribution is supposed as f and θ. At this time, θ is made up of a discrete matrix Σ and a mean vector μ. The method based on the multi-variate normal distribution is called graphical Gaussian modeling. Here, suppose M genetic expression levels are a random vector [el(Gene 1), el(Gene 2), . . . el(Gene M)] which follows a multi-variate normal distribution.

(Estimation of independent graph) Under an assumption of the multi-variate normal distribution, a factorization reference is equivalent to a partial correlation coefficient becoming 0 between certain two variables. That is, two variables are conditionally independent only when the partial correlation coefficient is 0. Obtaining the partial correlation coefficient requires an inverse matrix of a covariance matrix to be calculated.

When (Ω=Σ⁻¹)Ω=(ωᵢⱼ) is given, a partial correlation coefficient p^{ij, the rest} between el (Gene i) and el (Gene j) is calculated from elements of Ω as follows. This is given as p^{ij, the rest}=−ωᵢⱼ/(ωᵢᵢ×ωⱼⱼ). As shown in this expression, that the partial correlation coefficient is 0 corresponds to the inverse covariance being 0. The graphical Gaussian model is defined as such a model that sets a specific partial correlation coefficient to 0. In order to construct a graph structure by evaluating a conditionally independent relationship among genes, a gradual iteration algorithm developed by Wermuth and Scheidt et al. is used here. Instead of a covariance matrix and inverse covariance matrix, a correlation coefficient matrix and partial correlation coefficient matrix are used.

Step 0: This is an initialization step. A complete graph g(0)=(v, e) is provided. Vertices of this graph correspond to M genes and suppose all vertices are connected. This g(0) is called a “full model.” Based on the expression profile data, the first correlation coefficient matrix C(0) is calculated, where suppose r=0.

Step 1: A partial correlation coefficient matrix P(τ) is calculated from a correlation coefficient matrix C(τ), where τ indicates the number of iterations.

Step 2: An element whose absolute value is a minimum is searched from among all the elements of P(τ) and the element is substituted by 0.

Step 3: A correlation coefficient matrix C(τ+1) is reconstructed from P(τ). In C(τ+1), only the elements corresponding to the elements substituted by 0 in P(τ) are changed. On the other hand, all other elements are the same as the elements of C(τ).

Step 4: It is decided whether or not to stop the iterative calculation. The following three values are calculated for that purpose.
dev1=N log[|C(τ+1)|/|C(0)|]
dev2=N log[|C(τ+1)|/|C(τ)|]

|C(τ+1)|, |C(τ)|, |C(0)| each denote a determinant of each matrix. dev1 follows a χ² distribution with the degree of freedom=n and dev2 follows a χ² distribution with the degree of freedom=1. n denotes the number of elements set to 0 until the τth iteration takes place. N denotes the number of situations in which measurements are performed.

Step 5: When the probability of occurrence of a value equal to or higher than dev1 or dev2 is calculated according to the χ² distribution, if the probability value with respect to dev1 is 0.5 or less or if the probability value with respect to dev2 is 0.3 or less, the model corresponding to C(τ+1) is discarded and the iterative calculation is terminated. When the termination condition has not been satisfied, the side between the two genes whose partial correlation coefficient in P(τ) has been set to 0 is removed from g(τ) to have g(τ+1) and τ is advanced to τ+1 and the process is returned to step 1.

The graph finally obtained using the above described method is an undirected graph and expresses a conditionally independent relationship among random variables. This undirected graph is called an “independent graph.”

The graphical Gaussian modeling for specifically estimating a genetic network will be explained below with reference to a conventional technology. For those skilled in the art, it is understandable that the present invention can be implemented by introducing the above described method in a cluster analysis.

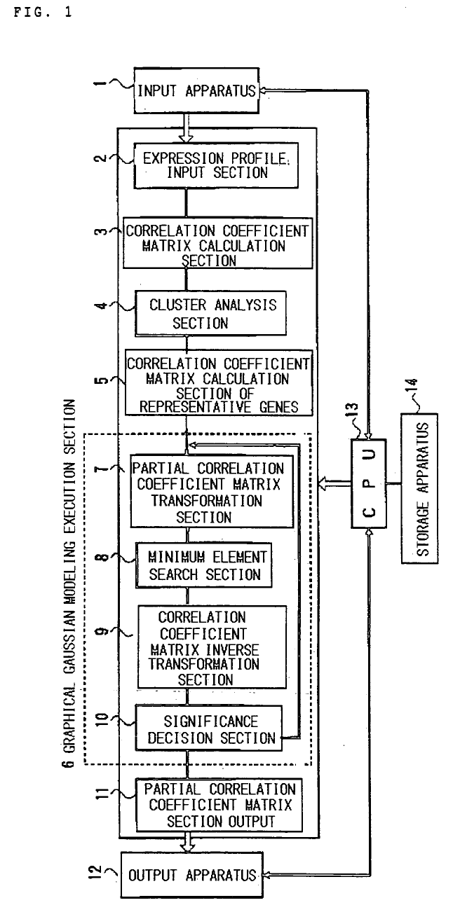

FIG. 1 is a block diagram of a graphical Gaussian modeling apparatus for estimating a genetic network.

In this figure, reference numeral 1 denotes an input apparatus; 2, an expression profile input section; 3, a correlation coefficient matrix calculation section; 4, a cluster analysis section; 5, a correlation coefficient matrix calculation section for representative genes; 6, a graphical Gaussian modeling execution section; 7, a partial correlation coefficient matrix transformation section; 8, a minimum element search section; 9, a correlation coefficient matrix inverse transformation section; 10, a significance decision section; 11, a partial correlation coefficient matrix output section; 12, an output apparatus; 13, a CPU (central processing unit); and 14, a storage apparatus.

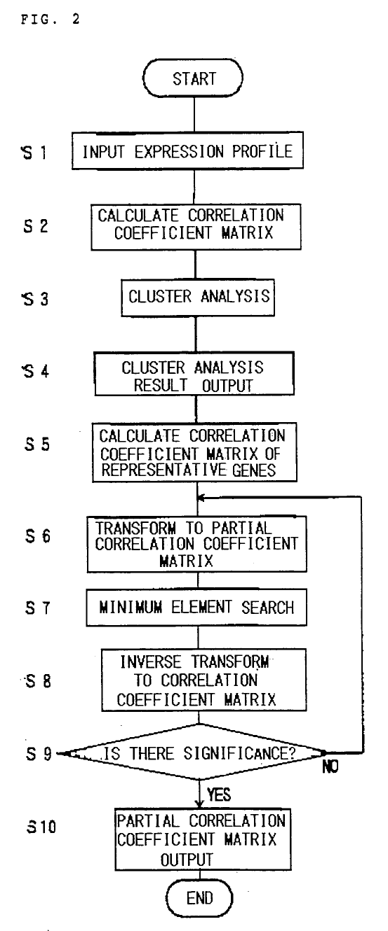

FIG. 2 is a flow chart of a graphical Gaussian modeling method for estimating a genetic network.

An outline of the graphical Gaussian modeling method will be explained with reference to FIG. 2.

A genetic expression profile is input (step S1), then a genetic correlation coefficient matrix is calculated (step S2), then a cluster analysis is performed (step S3), then a cluster analysis result is output (step S4), then a correlation coefficient matrix of representative genes is calculated (step S5), then a transform to a partial correlation coefficient matrix is performed (step S6), then a minimum element is searched (step S7), then an inverse transform to a correlation coefficient matrix is performed (step S8), then significance is decided (step S9), and when the significance decision result shows that there is no significance, the process moves back to step S6, and when the significance decision result shows that there is significance, the partial correlation coefficient matrix is output (step S10).

A specific example will be explained below.

(1) 2,467 genes of yeast to be subjected to a cluster analysis were classified into clusters in such a way that each row or each column of a correlation coefficient matrix with respect to its expression profile is linearly independent of each other among clusters in the sense of a numerical analysis.

As a result, the 2,467 genes were classified into 34 clusters.

(2) Graphical Gaussian modeling (GGM)

GGM was executed using the correlation coefficient matrix of the expression profiles of representative genes of the above described 34 clusters.

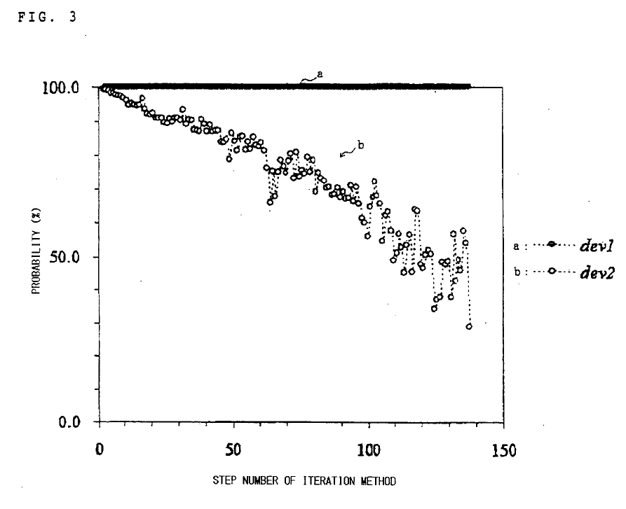

FIG. 3 shows plotting of variations in p-values of dev1 and dev2 in the process of GGM iterative calculations with respect to an iteration step. That is, in FIG. 3, the probability values of plots dev1 and dev2 with respect to the iteration step numbers of the probability values of dev1 and dev2 are used to decide whether or not to stop a GGM iterative calculation and they are plotted as a function of the number of iteration steps. o denotes the probability value of dev1 and [symbol] denotes the probability value of dev2.

As is clear from this figure, the p-value of dev1 is greater than 99.99% throughout the entire process as indicated by a in the figure and was therefore not used to evaluate whether or not to stop the iteration. On the other hand, the p-value of dev2 decreased as the iteration step advanced as indicated by b in the figure and the p-value became 0.284 falling below a set reference value of 0.3 when evaluating an element (9, 28) of the partial correlation coefficient matrix (PCCM) in the 137th step, and therefore the iteration was stopped. Therefore, this means that 136 elements in the PCCM were substituted by 0.0. As shown above, dev2 was more efficient in stopping the GGM iterative calculation.

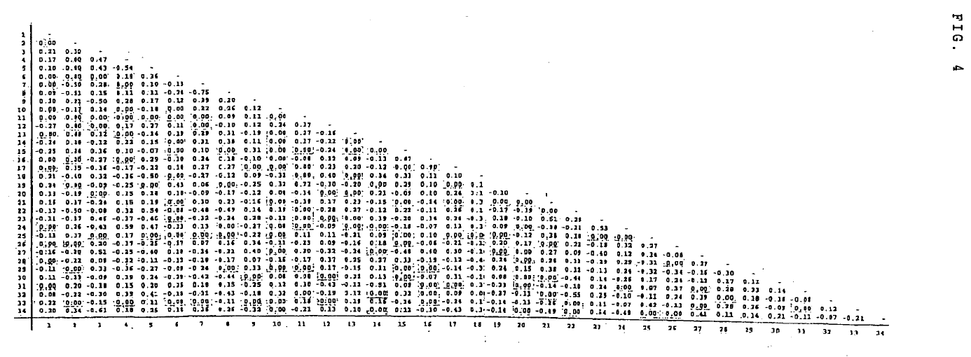

FIG. 4 illustrates a final PCCM of 34 representative genes obtained by the GGM. That is, shading in FIG. 4 shows the elements substituted by 0.0 in the process of iteration of the matrix GGM of the partial correlation coefficients obtained by the GGM.

Element (7, 8) was −0.75, the minimum in the PCCM and element (4, 24) was 0.59, the maximum. Of 561 PCCM elements, 136 elements were substituted by 0 (approximately 24%). In other words, 136 sides were deleted from the independent graph. The independent graph had no isolated node and there was no such node having sides in all other nodes, either. Of the nodes, the one having the maximum number of sides had 30 sides and the one having the minimum number of sides had 18 sides. Since it would be complicated to display all sides in the independent graph, only sides having absolute values of partial correlation coefficients exceeding 0.5 were shown in FIG. 5. That is, FIG. 5 shows an independent graph with 34 clusters and only sides corresponding to partial correlation coefficients whose absolute value exceeds 0.5 are shown.

This discussion will be further deepened below.

(1) If the number of samples of expression profile data of 2,467 genes appropriate for GGM of representative genes further increases, a division into clusters consisting of smaller members may also be possible. However, the discussion will be continued here assuming that the behavior of expressions of genes included in each of the 34 clusters obtained is similar to one another, that is, assuming that genes are under similar control and that the PCCM (FIG. 4) and independent graph (FIG. 5) of 34 genes represent a PCCM and independent graph among the 34 clusters.

However, the appropriateness of selection of representative genes will be described before that. There may be various ways to select representative genes and whether such differences in methods affect GGM results or not will be studied.

First, members of the 34 clusters other than the previously selected representative genes were selected at random and 100 sets of 34 representative genes were prepared. Since the logarithm of the ratio (when the ratio is smaller than 1, the reciprocal thereof is used) of the respective sets to a determinant of a correlation coefficient matrix of an expression profile of the previously selected representative genes multiplied by 561 is expected to follow a X square distribution with a degree of freedom of 561, the p-value thereof was calculated. Assuming that the significant level is 0.05, only 7 out of 100 sets were discarded as being significantly different from the original representative gene sets. Moreover, even when 0.3 and 0.5, the significant levels used to stop the iteration steps by dev1, dev2 in the GGM, were used, 9 and 11 sets out of the 100 sets were discarded as being significantly different from the original representative genes respectively. Though it does not necessarily guarantee that results of the GGM using different representative gene sets coincide with one another, this result strongly suggests that the result of the GGM conducted using one set of representative genes suffices.

(2) As described when interpreting sides using the independent graph, it is supposed here that non-zero elements of PCCM or sides of the corresponding independent graph indicate direct interaction between clusters. In this section, interpretation of the side will be examined. Generally, the non-zero elements of PCCM suggest direct interaction between pairs of variables. However, the non-zero elements of PCCM cannot indicate which variable is a cause and which variable is a result. Therefore, the sides in the independent graph are unidirectional. Without prior knowledge of the causal relationship, it is impossible to replace sides with arrows. The non-zero elements of PCCM shown in FIG. 4 are believed to indicate direct interactions between cluster pairs. At that time, what a direct interaction between clusters means will be explained.

It does not seem to be realistic that all genes included in a certain cluster affect the expressions of all genes within other clusters connected by sides. It is rather more thinkable that a subset of genes of a certain cluster affects the expression of a subset of genes of another cluster. Furthermore, sides among clusters may construct a loop. By way of example, suppose clusters A and B connected by one side. It is considered that the subset of genes of cluster B affects the expressions of the subset of genes of cluster A, while another subset of genes of cluster B affects the subset of cluster A. Thus, the influence caused by sides among clusters on genes may have a more complicated meaning than that of a direct interaction. In addition, it should be noted that the expression profile data studied here does not include many genes whose functions are unknown.

In the work of Eisen et al. (1998), the expression levels of 2467 genes of yeast whose function is identified were measured. However, according to Rubin et al. (2000), 6241 genes are expected to exist in yeast genomes as protein coders. Thus, it is not possible to discard the possibility that due to the lack of data, several sides may have been generated not by directly interacting genes but by indirectly interacting genes through expressions of genes whose function is unidentified.

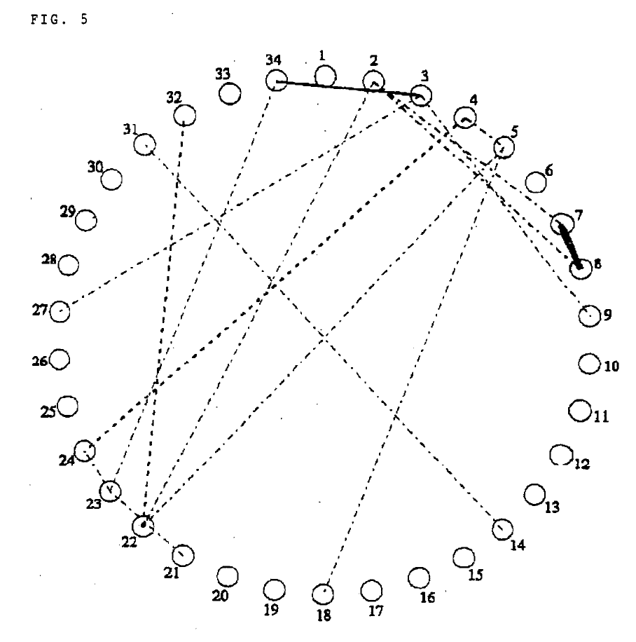

(3) The characteristic independent graph of an estimated genetic network included no isolated points. No node had sides for all other nodes, either. One of the important problems regarding genetic networks is whether a genetic network can be divided into several independent partial networks or not. This problem can be easily verified by examining whether an independent graph can be divided into several subgraphs which have no side for nodes of other partial graphs or not. An examination of the PCCM obtained (FIG. 4) suggests that such division is not possible. That is, the genetic network is functioning as a single system. FIG. 6 shows a PCCM summarized in a histogram form to characterize an adjustment mechanism of an estimated genetic network. That is, FIG. 6 shows a frequency distribution of partial correlation coefficients. The horizontal axis shows partial correlation coefficients. To calculate the frequency, the partial correlation coefficients are rounded to discrete data having a width of 0.1. The vertical axis shows the frequency of coefficients within the width. However, the frequency of 0.0 of partial correlation coefficients is plotted with respect to 0.0 on the horizontal axis.

The histogram in this FIG. 6 shows a frequency distribution of partial correlation coefficients. Of 561 PCCM elements, 239 have positive values, while 186 elements have negative values. Their respective numbers correspond to 43% and 33%. Furthermore, the distribution of the positive partial correlation coefficients was not symmetrical with respect to the distribution of the negative correlation coefficients. The distribution of the positive partial correlation coefficients had peaks in a range from 0.2 to 0.3. Moreover, there were no correlation coefficients in a range from 0.0 to 0.1. In contrast, the distribution of the negative partial correlation coefficients had peaks in a range from −0.2 to −0.3. The ends of the distribution extended on both sides compared to the case of the positive correlation coefficients. This observation suggests that the number of positive adjustments is greater than the number of negative adjustments.

Genes involved in a transfer of mRNA are most likely to get involved in an adjustment of genetic expressions. Therefore, a set of genes involved in a transfer in a cluster may play the central role in an adjustment of expressions of genes of other clusters connected by sides. Of the 34 clusters, 33 clusters are likely to get involved in a transfer of mRNA. However, their amount varies from one cluster to another. This observation suggests that the transfer of mRNA is subject to a parallel distribution type adjustment. The PCCM (FIG. 4) and independent graph (FIG. 5) may express an adjustment of expressions of genes involved in the expression of mRNA to a certain degree. On the other hand, the cluster 32 includes 40% or more of translation-related genes and approximately 50% of rRNA transfer-related genes. The number of sides connected to the cluster 32 is 28 and five sides have been removed in the process of the GGM. The content of translation-related genes in other clusters was low. Therefore, translation may rather adopt a concentrated adjustment system.

Here, focused on cell cycle adjustment genes, a model network has been simplified. Spelman et al. identified 294 cell cycle adjustment genes in yeast. Of 2467 genes used in this study, 232 genes corresponded to the cell cycle adjustment genes classified by Spelman et al. There are five cell cycle stages G1, S, G2, M, M/G1 and the respective stages include cell cycle length factors that have peculiar cyclic expressions. Of 232 genes, 93, 32, 28, 48, 31 genes are related to G1, S, G2, M, M/G1 respectively. Table 1 shows a distribution of genes in 34 clusters examined here.

TABLE 1
#1

| Cluster | G1 | S | G2 | M | M/G1 | Total |
|---|---|---|---|---|---|---|
| 1 | 0 | 0 | 0 | 1 | 0 | 1 |
| 2 | 1 | 5 | 1 | 1 | 1 | 9 |
| 3 | 0 | 0 | 0 | 0 | 0 | 0 |
| 4 | 1 | 1 | 1 | 1 | 0 | 4 |
| 5 | 0 | 0 | 1 | 0 | 0 | 1 |
| 6 | 0 | 0 | 0 | 0 | 0 | 0 |
| 7 | 15 | 4 | 10 | 4 | 2 | 35 |
| 8 | 1 | 1 | 1 | 0 | 0 | 3 |
| 9 | 8 | 0 | 1 | 5 | 1 | 15 |
| 10 | 0 | 0 | 0 | 1 | 2 | 3 |
| 11 | 12 | 9 | 0 | 1 | 2 | 24 |
| 12 | 36 | 6 | 3 | 2 | 0 | 47 |
| 13 | 1 | 0 | 0 | 1 | 0 | 2 |
| 14 | 0 | 1 | 0 | 4 | 1 | 6 |
| 15 | 2 | 0 | 1 | 1 | 0 | 4 |
| 16 | 0 | 1 | 0 | 0 | 1 | 2 |
| 17 | 0 | 0 | 0 | 0 | 0 | 0 |
| 18 | 0 | 0 | 0 | 0 | 2 | 2 |
| 19 | 0 | 0 | 0 | 0 | 1 | 1 |
| 20 | 1 | 1 | 0 | 1 | 3 | 6 |
| 21 | 1 | 0 | 0 | 0 | 0 | 1 |
| 22 | 1 | 0 | 0 | 1 | 1 | 3 |
| 23 | 1 | 0 | 2 | 2 | 4 | 9 |
| 24 | 1 | 0 | 2 | 2 | 1 | 6 |
| 25 | 1 | 0 | 1 | 9 | 0 | 11 |
| 26 | 1 | 1 | 0 | 1 | 2 | 5 |
| 27 | 1 | 0 | 0 | 2 | 1 | 4 |
| 28 | 3 | 0 | 0 | 0 | 1 | 4 |
| 29 | 0 | 1 | 0 | 0 | 0 | 1 |
| 30 | 1 | 1 | 0 | 4 | 2 | 3 |
| 31 | 2 | 0 | 0 | 1 | 3 | 6 |
| 32 | 1 | 0 | 2 | 2 | 0 | 5 |
| 33 | 0 | 0 | 0 | 0 | 0 | 0 |
| 34 | 1 | 0 | 2 | 1 | 0 | 4 |
| | 93 | 32 | 28 | 48 | 31 | 232 |

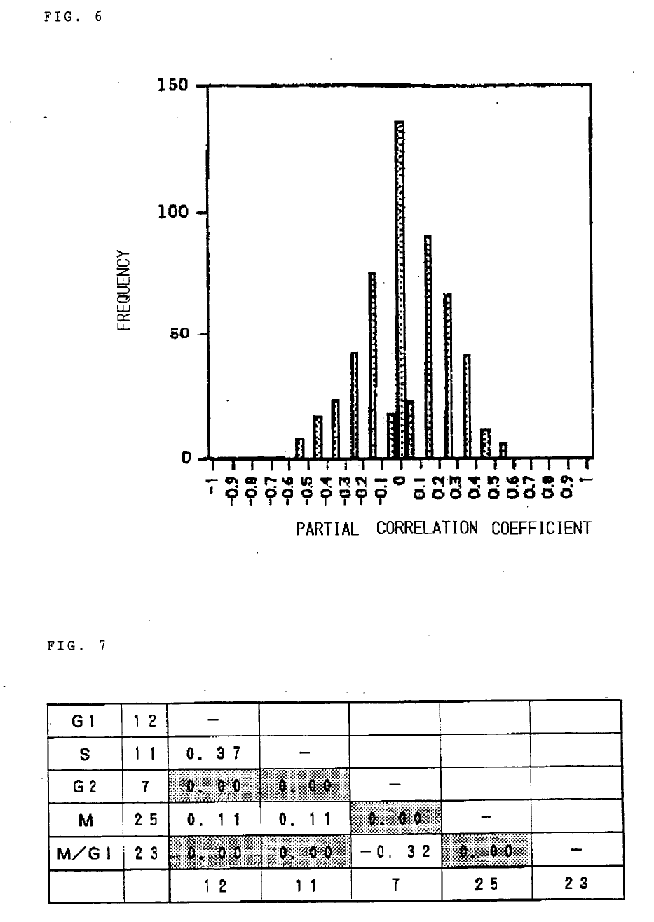

Of 34 clusters, 4 included no cell cycle adjustment genes. Cluster 12 included most G1-related cell cycle related genes. Likewise, clusters 7 and 25 included most cell cycle related genes involved in G2 and M2 respectively. Cell cycle related genes involved in S and M/G4 seem to exist distributed over several clusters, but relatively concentrated on clusters 11 and 12. Here, PCCM elements involved in clusters 7, 11, 12, 23, 25 were gathered. This is shown in FIG. 7. That is, FIG. 7 shows partial correlation coefficients among clusters 7, 11, 12, 23, 25.

As shown in FIG. 7, 6 out of 9 elements were 0. Furthermore two elements (11, 25) and (12, 25) had a small value of 0.11. Only elements of the pair of clusters 11 and 12 and elements corresponding to the pair of clusters 7 and 23 had large values of 0.37 and −0.32 respectively. This observation suggests that cell cycle adjustment genes involved in different cell cycles are mutually conditionally independent of each other in principle or have only a very weak relationship.

The present invention is the clustering technique in the above described embodiment with a unique improvement added and can be modified in various ways based on the spirit of the present invention. These modifications will not be excluded from the scope of the present invention.

As shown above, the present invention proposes a general graphical Gaussian modeling method for estimating a genetic network from an expression profile whereby genes closest to a mean value of clusters are considered as representative genes when determining representative genes of respective clusters, and can thereby perform calculations whose results are determined uniquely. Furthermore, there is a high probability that genes reflecting features of clusters may be selected. Furthermore, evaluations of VIF are stabilized and the probability that highly dependent VIFs may exist decreases. Therefore, inverse matrix calculations become more stable than conventional methods, producing an effect of improving the calculation accuracy. This will be explained below.

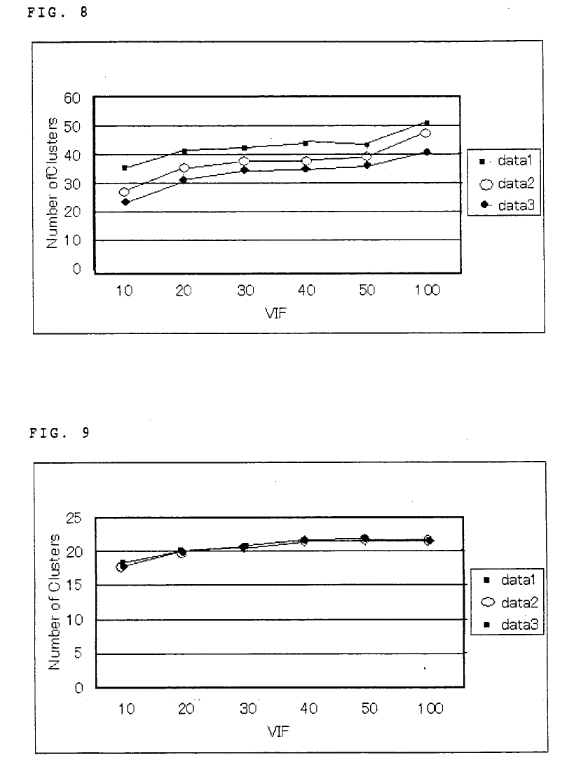

FIG. 8 shows experiment results using a conventional graphical Gaussian modeling method. The X-axis shows a VIF threshold and the Y-axis shows the estimated number of clusters. Furthermore, data 1 to 3 have changed gene presentation sequences. It can be seen that the conventional method considers the gene having the lowest number in a cluster as a representative gene and when the gene presentation sequence changes, the result of decision on the number of clusters for the VIF and the maximum number of clusters change and they are not constant. This is because the conventional method is a procedure that makes a decision through VIF considering the gene with the lowest number as the representative gene.

FIG. 9 shows experiment results using a general graphical Gaussian modeling method of the present invention. The general graphical Gaussian modeling method always obtains constant estimation results independently of the order in which genes are presented. This result indicates that the general graphical Gaussian modeling method detects more accurate separation limit points through estimation of more stable cluster boundaries.

What is claimed is:

1. A graphical Gaussian modeling method for estimating a genetic network comprising the steps of:
(a) clustering genes based on an expression profile of genes;
(b) selecting genes having a profile closest to a mean value of an expression profile per cluster to be used as representative genes representing said cluster;
(c) obtaining a correlation coefficient matrix among representative genes;
(d) obtaining a partial correlation coefficient matrix from said correlation coefficient matrix;
(e) contracting the partial correlation coefficient matrix according to predetermined conditions; and
(f) displaying a contracted model based on the contracted partial correlation coefficient matrix.

2. The graphical Gaussian modeling method according to claim 1, wherein said clustering proceeds with clustering until a maximum number of clusters is reached when the value of VIF falls below a predetermined reference value.

3. The graphical Gaussian modeling method according to claim 1, wherein said step of selecting the representative genes selects genes for which the sum of a cluster mean value and a square error becomes a minimum, as the representative genes.

4. The graphical Gaussian modeling method according to claim 1, wherein said step of contracting said partial correlation coefficient matrix according to predetermined conditions decides whether the result of χ square testing of deviance of a correlation coefficient matrix is equal to or greater than a predetermined value or not, further proceeds with contraction when the X square testing result is equal to or greater than the predetermined value, repeats the decision whether the χ square testing result is equal to or greater than the predetermined value and finishes contraction when the χ square testing result falls below the predetermined value.

5. A computer-readable medium embodying instructions for causing a computer to perform a Gaussian modeling method for estimating a genetic network when the instructions are read by the computer, the method comprising:
(a) clustering genes based on an expression profile of genes;
(b) selecting genes having a profile closest to a mean value of said expression profile per cluster to be used as representative genes representing said cluster;
(c) obtaining a correlation coefficient matrix among said representative genes;
(d) obtaining a partial correlation coefficient matrix from said correlation coefficient matrix; and
(e) contracting said partial correlation coefficient matrix according to predetermined conditions.

6. A graphical Gaussian modeling method for estimating a genetic network comprising the steps of:
obtaining an expression profile by measuring an expression level of a group of genes under various circumstances;
clustering genes based on said expression profile;
selecting genes having a profile closest to a mean value of said expression profile per cluster to be used as representative genes representing said cluster;
obtaining a correlation coefficient matrix among said representative genes;
obtaining a partial correlation coefficient matrix from said correlation coefficient matrix;
contracting said partial correlation coefficient matrix according to predetermined conditions; and
displaying a contracted model based on said contracted partial correlation coefficient matrix.

7. A graphical Gaussian modeling apparatus which estimates and displays a genetic network, comprising:
(a) an input section which receives the input of a genetic expression profile;
(b) a calculation section which clusters genes based on a genetic expression profile, selects genes having a profile closest to a mean value of an expression profile per cluster to be used as representative genes representing said cluster, obtains a correlation coefficient matrix among the representative genes, obtains a partial correlation coefficient matrix from said correlation coefficient matrix and can contract the partial correlation coefficient matrix according to predetermined conditions; and
(c) an output section which displays a contracted model based on said contracted partial correlation coefficient matrix.

8. A graphical Gaussian modeling apparatus that estimates and displays a genetic network, comprising:
(a) an input device adapted to receive input of a genetic expression profile;
(b) a computer processor and a computer-readable medium embodying instructions for causing said computer processor to perform a Gaussian modeling method when the instructions are read by said computer processor, the method comprising: clustering genes based on said genetic expression profile, selecting genes having a profile closest to a mean value of said expression profile per cluster to be used as representative genes representing said cluster, obtaining a correlation coefficient matrix among said representative genes, obtaining a partial correlation coefficient matrix from said correlation coefficient matrix and contracting said partial correlation coefficient matrix according to predetermined conditions; and
(c) an output device adapted to display a contracted model based on said contracted partial correlation coefficient matrix.
